(19) United States
(12) Patent Application Publication
(10) Pub. No.: US 2011/0185945 A1
(43) Pub. Date: Aug. 4, 2011

(54) Process for the Production of Titanium-IV-Phosphate

(75) Inventors: Bernd Proft, Neukirchen-Vluyn (DE); Martin Dehnen, Duisburg (DE)

(73) Assignee: SACHTLEBEN CHEMIE GMBH, Duisburg (DE)

(21) Appl. No.: 13/063,943

(22) PCT Filed: Sep. 15, 2009
(86) PCT No.: PCT/EP09/61980

§ 371 Date: Apr. 20, 2011

(30) Foreign Application Priority Data
Sep. 16, 2008 (DE) 10 2008 047 533.5

(51) Int. Cl. C09D 1/00

(52) U.S. Cl. 106/286.4

(57) ABSTRACT

A process for the production of titanium-IV-phosphate includes introducing a titanium-oxygen compound into aqueous phosphoric acid and treating the resulting suspension in a temperature range of more than 50° C. to 150° C. until complete dissolution of the titanium-oxygen compound.

The invention concerns a process for the production of titanium-IV-phosphate in the form of a phosphate-acid solution and in particle form as well as the use thereof for the treatment of surfaces.

Phosphating with aqueous solutions based on zinc phosphate makes it possible to produce zinc phosphate layers on numerous metallic surfaces such as iron, steel, alloy-galvanised steel, aluminium or aluminium-plated steel. The application of the phosphating solutions which besides zinc and phosphoric acid can also contain further cations and anions is effected using spray, dip or spray/dip processes. The zinc phosphate layers obtained serve for corrosion protection, lacquer and paint bonding, reducing sliding resistance, facilitating cold shaping and for electrical insulation.

A phosphating process, besides the phosphating operation itself, also includes various preliminary or subsequent treatment stages. What is indispensable is cleaning of the metal surface, which is generally effected with alkaline or acid cleaners and cleans oils, greases, oxides and solid particles adhering thereto, off the metal surface. If cleaning is effected with mildly alkaline cleaners it is in principle possible to combine cleaning with activation of the metal surface. Generally however activation follows the cleaning operation, as a separate step in the process.

The purpose of activation of the metal surface is to ensure the production of a zinc phosphate layer which is as finely crystalline as possible, in the shortest possible phosphating times. Therefore the minimum phosphating time is one criterion in regard to the action of an activation agent. The suitability for also producing finely crystalline zinc phosphate layers can be ascertained on the basis of the layer weights or by scanning electron-microscope imaging.

In practice activation agents based on titanium-IV-phosphate have also proven successful. Titanium-IV-phosphates are formed in the reaction of aqueous titanium-IV-salt solutions with soluble phosphates or phosphoric acid. Products with activation properties however are only obtained under particular manufacturing conditions which are described for example in U.S. Pat. Nos. 2,310,239 and 2,456,947 and set out precise details in regard to the nature and concentration of the raw materials, temperature and pH range in manufacture. Nonetheless even when observing constant reaction conditions, fluctuations in the technical effect in respect of use occur from one batch to another.

A disadvantage when using titanium-IV-phosphate-based activation agents is that the activation baths have to be prepared with fully desalinated water. The reason for this is that the alkali earth metal ions present in mains or tap water as hardening constituents destabilise titanium-IV-phosphate in activation baths. Those alkali earth metal ions can also be entrained into the activation bath by flushing water.

The improvement in stability of the activation baths in relation to water hardness by additives or the improvement in quality in respect of service life of the activation baths and crystallinity of the zinc phosphate coating applied in the subsequent stage by chelating agents however also suffer from serious disadvantages. One disadvantage in particular of chelating agents is that they act as phosphating bath poisons and cause difficulties in regard to waste water treatment as they put or hold heavy metals in solution.

EP 264 151 discloses a process for producing phosphate coatings on composite components of steel and galvanised steel by alkaline cleaning, rinsing with an aqueous rinsing bath and zinc phosphating as well as the use thereof for the preparation of such composite components for subsequent painting, in particular electrodip painting.

Similarly EP 454 211 concerns an activation agent based on titanium-IV-phosphate for the activation of metal surfaces prior to zinc phosphating and the use thereof for the preparation of activation baths.

In regard to versatile use options, there is a wish for a simple production process for titanium-IV-phosphate, and therefore the object of the invention is to provide such a process and in addition to produce an inorganic phosphate which can be used in heavy metal-free corrosion protection and in flame protection and which can additionally occur in an easily applicable fluid form.

That object is attained by the treatment of titanium dioxide with phosphoric acid. Usually, surface-rich titanium dioxide types and titanium dioxide precursors react with phosphoric acid to give difficultly soluble solid bodies. Surprisingly the inventors succeeded in producing a sol of theoretical Ti₃(PO₄)₄ in phosphoric acid with a theoretical Ti₃(PO₄)₄ content of 100-120 g/l of phosphoric acid by the reaction of titanium dioxide with concentrated phosphoric acid with a concentration of 85% by weight, preferably more than 89% by weight.

Accordingly the invention is directed to a process for the production of titanium phosphate, which includes the following steps:
introducing a titanium-oxygen compound into aqueous phosphoric acid with a concentration of more than 85% by weight;
treating the resulting suspension in a temperature range of more than 50° C. to 150° C. until complete dissolution of the titanium-oxygen compound,
   wherein the titanium-oxygen compound is used in step a) in dried form.

Preferably in the process according to the invention the titanium-oxygen compound is used in step a) in a form of being dried to mass constancy at temperatures of less than 110° C.

Further preferably the titanium-oxygen compound is used in step a) in purified form, in particular as titanium dioxide and in particular in the anatase modification.

In that respect the use of the titanium-oxygen compound in step a) in particle form with a crystallite size of 7 to 300 nm is to be preferred.

As a possible titanium-oxygen compound, mention is to be made of titanium oxides or hydroxides which are suitable as starting materials and which can be selectively employed, which are commercially available under the designation S 150, S 140 and S 240 from Kemira, under the designation P 25 from Degussa, as VKR 611, Hombikat UV100 and Hombifine N from Sachtleben, XT 25376 from Norton, DT 51 from Thann et Mulhouse as well as Bayoxide TA-DW-1, Bayoxide T A-K-1 from Bayer. The titanium dioxide Hombifine N was found to be most suitable.

Hombifine N is dissolved particularly well in the concentrated phosphoric acid, but preferably should be previously dried under mild conditions (maximum 110° C.) to mass constancy. Excessively intensive drying for example at 130° C. and 150° C. leads to poorer solubility, likewise if the product still contains a great deal of residual moisture. Accordingly the titanium dioxide is preferably dried to mass constancy.

As the titanium-oxygen compound, the titanium dioxide is preferably used in an amount of 0.1 to 2.0 mol/l of phosphoric acid.

In the laboratory it was possible to produce a titanium phosphate solution for example with calculated about 110 g/l of Ti₃(PO₄)₄ from Hombifine N and 89% orthophosphoric acid. In that respect the solubility of titanium oxide in orthophosphoric acid is greatly dependent on the water content of the phosphoric acid, and likewise the selected starting product and the preliminary treatment thereof, that is to say substantially drying.

Although solubility in 85% phosphoric acid is sufficient, improved solubility in 89% phosphoric acid was observed, as is preferably used to produce the solution. The use of more highly concentrated phosphoric acid therefore makes it possible to achieve still better solubility of titanium dioxide. That is possible on the one hand by the addition of phosphoric pentoxide to phosphoric acid with 85% by weight, preferably 89% by weight, and on the other hand by the use of pure crystalline phosphoric acid which however first has to be melted (melting point about 42° C.).

The phosphate-acid solution of titanium phosphate, which can be obtained in accordance with the invention, can already be used for the surface treatment of metals and inorganic particles.

Although the compound formed is here referred to as titanium phosphate this can also involve compounds such as titanyl phosphate or mixtures of titanium phosphate. The crucial consideration is that the process according to the invention is carried out.

It is equally possible firstly to produce titanium phosphate in particle form from the phosphate-acid solution. For that purpose that phosphate-acid solution is firstly filtered. That is followed by neutralisation of the resulting filtrate with for example aqueous ammonia solution, separation off and washing of the precipitated particles with water, and drying of the particles, preferably at elevated temperature. The resulting particles can be dissolved again for use in concentrated phosphoric acid (>85%).

The titanium-IV-phosphate produced according to the invention can be employed for example for the activation of metal surfaces prior to zinc phosphating, it is simple to produce and in its use in the preparation of activation baths leads to stable activation baths with a long service life which in addition guarantee the production of finely crystalline zinc phosphate layers in a short time.

By means of titanium-IV-phosphate, in particular in a phosphate-acid solution, it is possible to prevent the corrosion of metallic surfaces, and it is possible to achieve phosphating of the surface, where a conversion layer of firmly adhering metal phosphates is formed by chemical reactions of metallic surfaces with the titanium-IV-phosphate solution. That phosphating can be used in relation to steel but it can also be employed for galvanised or cadmium-plated steels and aluminiums. Main areas of use according to the invention are corrosion protection, bonding priming, reduction of friction and wear, and electrical insulation.

In regard to the phosphating operation an etching attack is firstly carried out on the material, in which metal cations are dissolved, with the production of hydrogen. That is then followed by layer formation by the precipitation of difficultly soluble phosphates. In the layer-forming phosphating operation which is carried out in that way, layer construction is also effected by titanium cations from the phosphate solution, in addition metal cations from the basic material are involved.

The phosphate layer obtained in accordance with the invention in that way adheres very well to the substrate and permits good anchorage of subsequent coatings, by virtue of the microporous or microcapilliary layer structure. For that reason the phosphate layer produced in that way can be very well used as a substrate for further coatings. In addition it hinders rusting under damaged locations in the coating.

Corrosion protection in respect of the phosphating can be improved by waxing or oiling. The phosphate layers have good sliding properties, which can be utilised for cold working of steel.

In addition the titanium-IV-phosphate produced according to the invention can be used in the flame protection of plastic materials, by an intumescence layer being produced on the substrate to be protected. ‘Swelling’ or foaming-up of materials, serving as fire-proofing, is referred to in the art as intumescence. Such intumescent building materials increase in volume under the effect of heat and decrease in density and are generally employed in preventative structural fire protection.

Thus the titanium phosphate according to the invention can be used generally for surface treatment of metals, graphite electrodes, inorganic particles and organic materials such as textile materials, where the important consideration is the application of a passivating protective layer to the surface of the substrate.

### EXAMPLE OF PRODUCTION

Starting Materials:
Hombifine N, pre-dried for 4 hours at 110° C., and
orthophosphoric acid, w (H₃PO₄)=89%, very pure.

75 g of Hombifine N was introduced into 1.5 L of 89% phosphoric acid and dissolved for 4 hours at 95° C. That was followed by protection filtration over glass fibre filters MN 85/90. The clear yellowish solution has calculated about 110 g/L of Ti₃(PO₄)₄. The solution was investigated in respect of the Ti and phosphate content and characterised by a UV/VIS measurement.

In order to be able to better characterise the product, 250 ml of the solution was diluted with 500 ml of TE water and precipitated with 25% NH₃ solution within about 15 mins to pH 6. In that case the temperature rose to 70° C. Heating to 80° C. was effected and kept at that temperature for 2 hours. Then the product in gel form was filtered over a glass fibre filter MN 85/90 and washed. After washing for four days and re-suspension twice on each occasion in about 2 L of hot TE water, it was possible to achieve a conductivity in the washing filtrate of about 700 pS/cm. The washing operation was then terminated. The solid obtained was dried at 130° C. The solid was characterised by specific surface area, porosimetry, UV/VIS, X-ray diffractometry and REM.

1. A process for the production of titanium phosphate, comprising:
a) introducing a titanium-oxygen compound into aqueous phosphoric acid having a concentration of more than 85% by weight phosphoric acid;
b) treating the resulting suspension in a temperature range of more than 50° C. to 150° C. until complete dissolution of the titanium-oxygen compound,
wherein the titanium-oxygen compound used in step a) is in dried form.

2. A process according to claim 1 further comprising:
c) filtering the solution obtained in step b);
d) neutralising the filtrate obtained in step c) with aqueous ammonia solution;
e) separating off and washing precipitated particles with water,
f) drying the particles at elevated temperature, and
g) re-dissolving the particles in aqueous phosphoric acid having a concentration of more than 85% by weight phosphoric acid.

3. A process for the production of titanium phosphate according to claim 1 wherein the titanium-oxygen compound used in step a) is in a form of dried to mass constancy at temperatures of less than 110° C.

4. A process for the production of titanium phosphate according to claim 1 wherein the titanium-oxygen compound used in step a) is in purified form.

5. A process for the production of titanium phosphate according to claim 1 wherein the titanium-oxygen compound used in step a) is in the anatase modification.

6. A process for the production of titanium phosphate according to claim 1 wherein the titanium-oxygen compound used in step a) is in particle form and has a crystallite size of 7 to 300 nm.

7. A process according to claim 1 wherein titanium dioxide is used in an amount of 0.1 to 2.0 mol/l phosphoric acid as the titanium-oxygen compound.

8. A process according to claim 1 wherein the aqueous phosphoric acid has a concentration of more than 89% by weight phosphoric acid.

9. A titanium phosphate solution obtained by the process according to claim 1.

10. (canceled)

11. A method of treating a surface comprising applying a phosphate-acid solution of titanium phosphate obtained according to claim 1 to a metal, graphite electrode, inorganic particle, or organic material.

12. A method of treating a surface comprising applying a phosphate-acid solution of titanium phosphate obtained according to claim 2 to a metal, graphite electrode, inorganic particle, or organic material.
